(19) United States
(12) Patent Application Publication
(10) Pub. No.: US 2006/0294109 A1
(43) Pub. Date: Dec. 28, 2006

(54) Network device, local area network system and network transmitting method

(75) Inventors: Tenlong Dan, Taipei (TW); Jen-Ya Huang, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/435,767

(22) Filed: May 18, 2006

(30) Foreign Application Priority Data
Jun. 22, 2005 (CN) 094120845

(51) Int. Cl. G06F 17/30

(52) U.S. Cl. 707/10

(57) ABSTRACT

A network device connects an internet and an intranet. The network device includes a receiving module, a downloading module and a determining module. In this case, the receiving module receives a download request transmitted via the intranet. The downloading module downloads at least one data via the internet according to the download request. The determining module determines if the receiving module receives a connect request transmitted via the intranet, wherein the downloading module slows the rate of downloading the data or pauses downloading the data while the receiving module receives the connect request transmitted via the intranet.

### BACKGROUND OF THE INVENTION

1. Field of Invention

The invention relates to a network device, a Local Area Network system, and a network transmitting method and, in particular, to a bandwidth-shared network device, a bandwidth-shared Local Area Network system, and a bandwidth-shared network transmitting method.

2. Related Art

Referring to FIG. 1, a conventional network device 11 connects an internet 12 and an intranet 13. Hosts 131, 132 located in the intranet 13 have to share the bandwidth between the network device 11 and the internet 12 with each other. When the host 131 downloads lots of data via the internet 12, the host 131 occupies more bandwidth between the network device 11 and the internet 12 than the host 132.

On the other hand, when the host 131 or the host 132 does not ask the network device 11 to download the data via the internet, the data flow between the network device 11 and the internet 12 is lower than the normal time. Thus, the bandwidth between the network device 11 and the internet 12 is not used efficiently at this time.

It is an important subject of the invention to provide a network device, which can adjust the download rate in accordance with other requirements from the intranet. Therefore, the bandwidth between the network device and the internet can be used efficiently in various situations.

### SUMMARY OF THE INVENTION

In view of the foregoing, the invention is to provide a network device, a Local Area Network system, and a network transmitting method which are able to use the bandwidth of the internet efficiently.

To achieve the above, a embodiment of the invention provides a network device that connects an internet and an intranet. The network device includes a receiving module, a downloading module and a determining module. In this case, the receiving module receives a download request transmitted via the intranet. The downloading module downloads at least one data via the internet according to the download request. The determining module determines if the receiving module receives a connect request transmitted via the intranet, wherein the downloading module slows the rate of downloading the data or pauses downloading the data while the receiving module receives the connect request transmitted via the intranet.

In addition, to achieve the above, a embodiment of the invention provides a Local Area Network system connecting to an internet. The Local Area Network system includes an intranet and a network device. In this case, the intranet has a first host, wherein the first host transmits a download request. The network device connects the internet and the intranet and has a receiving module, a downloading module, and a determining module. The receiving module receives the download request, and the downloading module downloads at least one data via the internet according to the download request. The determining module determines if the receiving module receives a connect request transmitted via the intranet, wherein the downloading module slows the rate of downloading the data or pauses downloading the data while the receiving module receives the connect request transmitted via the intranet.

Furthermore, to achieve the above, a network transmitting method of the invention applies to an intranet connecting with an internet. In this case, the method includes transmitting a download request from a host located in an intranet; downloading at least one data via the internet according to the download request; receiving a connect request transmitted via the intranet; and slowing the rate of downloading the data or pausing downloading the data.

As mentioned above, the network device, the Local Area Network system, and the network transmitting method of the invention can downloads the predefined data via the internet when the intranet does not ask the network device to download the data via the internet. On the other hand, if the intranet transmits the connect request to the receiving module of the network device, the downloading module of the network device will slows the rate of downloading the predefined data or pauses downloading the predefined data so that the connect request from the host located in the intranet has a priority to use the internet resource. Hence, the network device and the Local Area Network system have the determining module to determine if the connect request transmitted by other hosts located in the intranet, so as to slow the rate of downloading the predefined data or pauses downloading the predefined data. Thus, the bandwidth between the network device and the internet can be used efficiently all the time. Further, the use efficiency of the intranet can also be increased.

### BRIEF DESCRIPTION OF THE DRAWINGS

The invention will become more fully understood from the detailed description given herein below illustration only, and thus is not limitative of the present invention, and wherein:

FIG. 1 is a block diagram showing the conventional network device;

FIG. 2 and FIG. 3 are block diagrams showing the network device according to a first preferred embodiment of the invention; and

FIG. 4 is a flowchart showing the network transmitting method according to a third preferred embodiment of the invention.

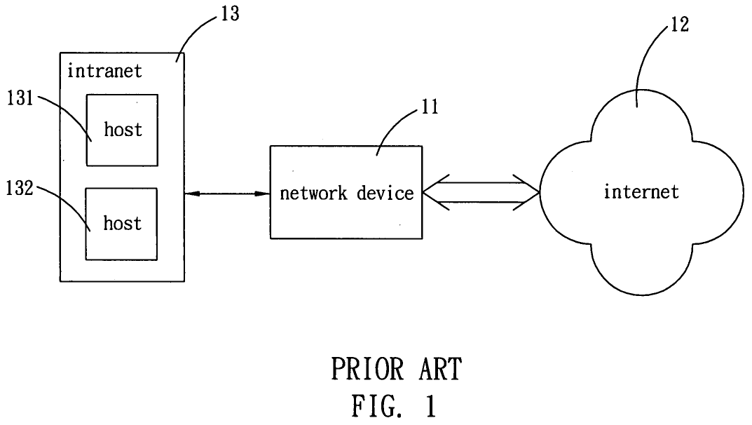

### DETAILED DESCRIPTION OF THE INVENTION

The present invention will be apparent from the following detailed description, which proceeds with reference to the accompanying drawings, wherein the same references relate to the same elements.

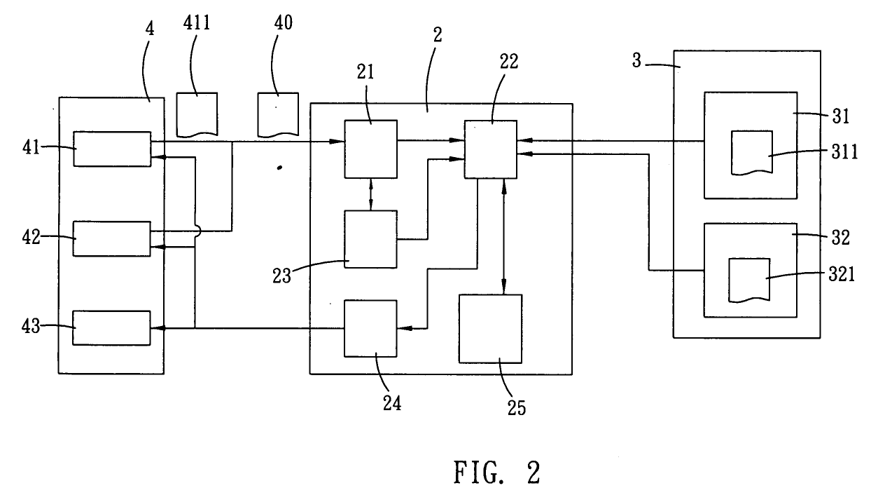

Referring to FIG. 2, a network device 2 according to a first preferred embodiment of the invention connects an internet 3 and an intranet 4. The network device 2 includes a receiving module 21, a downloading module 22, a determining module 23, and an address generating module 25. The intranet 4 includes a first host 41 and a second host 42.

In the embodiment, the first host 41 transmits a download request 411 according to File Transfer Protocol (FTP), Hypertext Transfer Protocol (HTTP), or the other transfer protocol, such as Point-to-Point Protocol (e.g. BT or EDONKEY). The download request 411 designates at least one data 311 at a particular node of the internet 3, such as the data 311 at a first node 31.

In addition, the receiving module 21 receives the download request 411 transmitted via the intranet 4, and the downloading module 22 downloads the data 311 via the internet 3 according to the download request 411.

Furthermore, the download request 411 includes a download address and a download condition. The download address can be the first node 31 of the internet 3. The download condition can be a file name, a logic rule of the main file name (for example, the main file name may have “asvs” four characters), a file format (for example, a secondary file name can be DOC, MPG or JPG etc.), a key data (e.g. a data author, a data content, or time etc.) or other kinds of the logic rules. The downloading module 22 downloads the data 311 of the first host 31 corresponding to the download address via the internet according to the download condition.

Moreover, the download request 411 can only include the download condition. The address generating module 25 can store the download addresses which the users often use. The download addresses can be classified in accordance with the keywords. For example, when the download condition includes the keyword “video” and “baseball”, the downloading module 22 searches the download address 251 related to the keyword “video” and “baseball” from the address generating module 25, and then connects with the correspond download address, such as Major League Baseball's website, to download the baseball video.

In the current embodiment, the determining module 23 determines if the receiving module 21 receives a connect request 40 transmitted via the intranet 4. Herein, the first host 41 or the second host 42 generates the connect request 40. In the current embodiment, the downloading module 22 slows the rate of downloading the data 311 or pauses downloading the data 311, while the receiving module 21 receives the connect request 40 transmitted via the intranet 4. Thus, the host transmitting the connect request 40 can ask the network device 2 to connect to the internet 3.

That is to say, when the requirement of connecting the intranet 4 with internet 3 is increased, the downloading module 22 of the network device 2 slows the rate of downloading the data 311 or pauses downloading the data 311, so that other hosts located in the intranet 4 can connect to the internet 3 successfully. On the other hand, when the requirement of connecting the intranet 4 with the internet 3 is decreased, the downloading module 22 can keep on downloading the data 311 again. Thus, the bandwidth between the network device 2 and the internet 3 can be used efficiently in various situations, and the use efficiency of the intranet can also be increased.

In the embodiment, the network device 2 can be a router, an IP sharer, a modem, a gateway, a hub, or a switch.

In addition, the network device 2 further includes a transmitting module 24. The intranet 4 further includes a memory device 43. In this case, the transmitting module 24 transmits the data 311 downloaded by the downloading module 22 to the intranet 4. Thus, the transmitting module 24 can transmit the data 311 to the first host 41, the second host 42 or the memory device 43 in accordance with the setting by users.

The transmitting module 24 transmits the data 311 to the memory device 43, and the memory device 43 stores the data 311. The memory device 43 can be a hard disk, a flash disk, or an optical recorder. Thus, the user can operate the first host 41 to ask the network device 2 to store the downloaded data to the memory device 43. For example, the user can designate the network device 2 to store the download data to the memory device 43 when the intranet does not connect with the network device 2, so that the bandwidth between the network device 2 and the internet 3 can be used efficiently in various situations. Thus, the network device 2 can automatically download the predefined data.

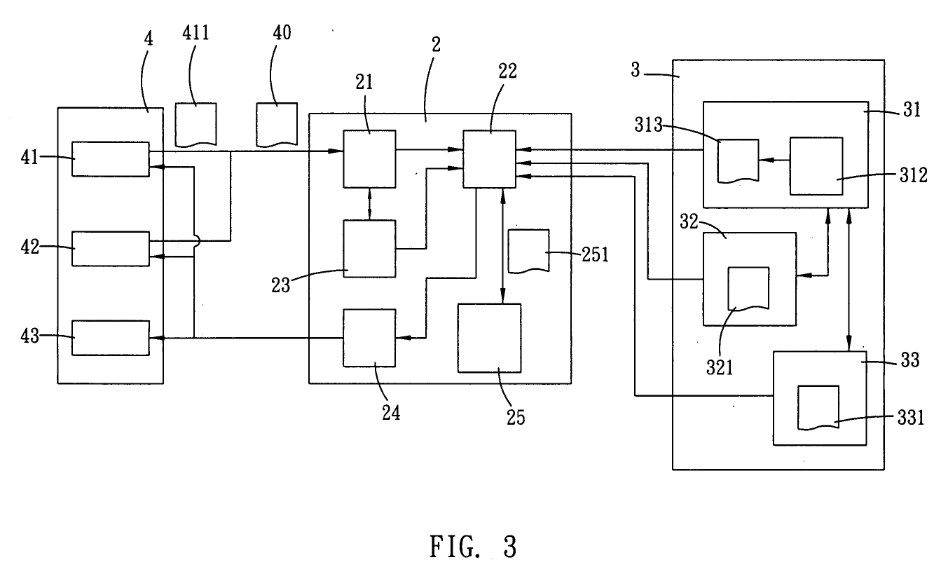

Referring to FIG. 3, another example is described as below. Generally, Point-to-Point Protocol (e.g. BT) can divide a file into many file pieces and put these file pieces at different download nodes. Thus, a second node 32 has a file piece (data 321), and the third node 33 has another file piece (data 331). In this case, a tracker 312 of the first node 31 tracks the addresses of the second node 32 and the third node 33, and records the file pieces which the second node 32 and the third node 33 save respectively to a list data 313.

After the receiving module 21 receives the download request 411 transmitted via the intranet 4, the downloading module 22 connects with the first node 31 (a tracker server) to download the list data 313 via the internet according to the download request 411 so as to search the data 321, 331.

Then, the downloading module 22 receives the list data 313, and the address generating module 25 generates at least one download address according to the list data 313. The downloading module 22 downloads the data 321, 331 from the second node 32 and the third node 33 respectively corresponding to the download address 251.

Moreover, a Local Area network system according to a second preferred embodiment of the invention is also shown in FIG. 2. In the present embodiment, the elements, characteristics and functions of the Local Area network system are same as described in the first preferred embodiment, and detailed descriptions thereof will be omitted.

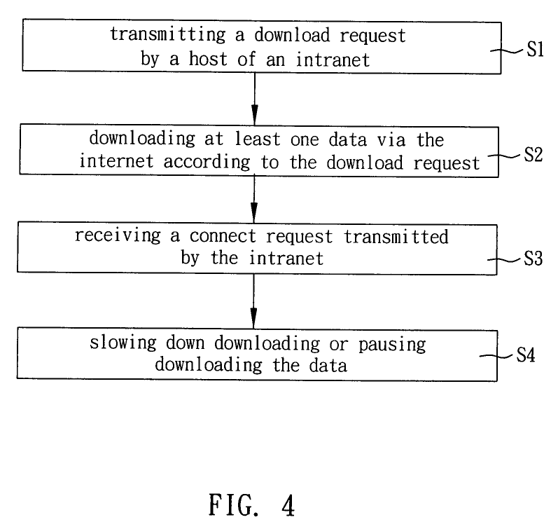

Referring to FIG. 4, a network transmitting method according to a third preferred embodiment of the invention, which applies to an intranet connecting with an internet. The network transmitting method includes steps S1 to S4.

Step S1 is transmitting a download request from a host located in the intranet. Step S2 is downloading at least one data via the internet according to the download request. Step S3 is receiving a connect request transmitted via the intranet. Step S4 is slowing the rate of downloading the data or pausing downloading the data.

Moreover, the network transmitting method applies to the network device of the first preferred embodiment which is shown in FIG. 2, and the detailed descriptions thereof will be omitted.

As mentioned above, the network device, the Local Area Network system, and the network transmitting method of the invention can downloads the predefined data via the internet when the intranet does not connects with the network device to download the data via the internet. On the other hand, if the intranet transmits the connect request to the receiving module of the network device, the downloading module of the device will slows the rate of downloading the predefined data or pauses downloading the predefined data so that the connect request from the host located in the intranet has a priority to use the internet resource. Hence, the network device and the Local Area Network system have the determining module to determine if the connect request transmitted by other hosts located in the intranet, so as to slow the rate of downloading the predefined data or pauses downloading the predefined data. Thus, the bandwidth between the network device and the internet can be used efficiently all the time. Further, the use efficiency of the intranet can also be increased.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A network device, which connects an internet and an intranet, comprising:
a receiving module, which receives a download request transmitted via the intranet;
a downloading module, which downloads at least one data via the internet according to the download request; and
a determining module, which determines whether the receiving module receives a connect request transmitted via the intranet, wherein the downloading module slows the rate of downloading the data or pauses downloading the data while the receiving module receives the connect request transmitted via the intranet.

2. The network device according to claim 1, further comprising:
a transmitting module, which transmits the data downloaded by the downloading module to a memory device located in the intranet.

3. The network device according to claim 1, wherein the download request comprises a download address and a download condition, the downloading module downloads the data from a host corresponding to the download address via the internet according to the download condition.

4. The network device according to claim 1, wherein the download condition comprises a file name, a file format, or a key data.

5. The network device according to claim 1, further comprising:
an address generating module, which generates at least one download address according to a list data, wherein the downloading module connects with a tracker server to download the list data via the internet according to the download request, the downloading module downloads the data from a host corresponding to the download address via the internet.

6. The network device according to claim 1, wherein the network device is a router, an IP sharer, a modem, a gateway, a hub, or a switch.

7. A Local Area Network system, which connects to an internet, comprising:
an intranet, which has a first host, wherein the first host transmits a download request; and
a network device, which connects the internet and the intranet and has a receiving module, a downloading module, and a determining module, the receiving module receives the download request, the downloading module downloads at least one data via the internet according to the download request, the determining module determines if the receiving module receives a connect request transmitted via the intranet, wherein the downloading module slows the rate of downloading the data or pauses downloading the data while the receiving module receives the connect request transmitted via the intranet.

8. The Local Area Network system according to claim 7, wherein the connect request is transmitted by a second host or the first host located in the intranet.

9. The Local Area Network system according to claim 7, wherein the network device further comprises a transmitting module, the transmitting module transmits the data downloaded by the downloading module to the intranet.

10. The Local Area Network system according to claim 9, wherein, the transmitting module transmits the data downloaded by the downloading module to the first host.

11. The Local Area Network system according to claim 9, wherein the intranet further comprises a memory device, the memory device stores the data.

12. The Local Area Network system according to claim 11, wherein, the memory device is a hard disk, a flash disk, or an optical recorder.

13. The Local Area Network system according to claim 7, wherein the download request includes a download address and a download condition, the downloading module downloads the data from a host corresponding to the download address via the internet according to the download condition.

14. The Local Area Network system according to claim 7, wherein the download condition comprises a file name, a file format, or a key data.

15. The Local Area Network system according to claim 7, wherein the network device comprises an address generating module generating at least one download address according to a list data, the downloading module connects with a tracker server to download the list data via the internet according to the download request, the downloading module downloads the data from a host corresponding to the download address via the internet.

16. The Local Area Network system according to claim 7, wherein the network device is a router, an IP sharer, a modem, a gateway, a hub, or a switch.

17. A network transmitting method, which applies to an intranet connecting with an internet, the method comprising:
transmitting a download request from a host located in the intranet;
downloading at least one data via the internet according to the download request; and
receiving a connect request transmitted via the intranet; and
slowing the rate of downloading the data or pausing downloading the data.

18. The network transmitting method according to claim 17, further comprising:
transmitting the data downloaded via the internet to the intranet.

19. The network transmitting method according to claim 17, further comprising:
storing the data to a memory device.

20. The network transmitting method according to claim 19, wherein the memory device is a hard disk, a flash disk, or an optical recorder.

21. The network transmitting method according to claim 17, wherein the step of downloading the data via the internet according to the download request comprises downloading the data from a host correspond to a download address of the download request via the internet according to a download condition of the download request.

22. The network transmitting method according to claim 21, wherein the download condition comprises a file name, a file format, or a key data.

23. The network transmitting method according to claim 17, wherein the step of downloading the data via the internet according to the download request comprises:
connecting with a tracker server to download a list data via the internet according to the download request;
generating at least one download address; and
downloading the data from a host corresponding to the download address via the internet.
